(19) United States
(12) Patent Application Publication
(10) Pub. No.: US 2022/0375099 A1
(43) Pub. Date: Nov. 24, 2022

(54) SEGMENTATING A MEDICAL IMAGE

(71) Applicants: KONINKLIJKE PHILIPS N.V., EINDHOVEN (NL); PETER THE GREAT ST. PETERBURG STATE POLYCHNIC UNIVERSITY, ST. PETERBURG (RU)

(72) Inventors: HEINRICH SCHULZ, NORDERSTEDT (DE); VIACHESLAV SERGEEVICH CHUKANOV, HAMBURG (DE); MIKAHAIL VLADIMIROVICH POZIGUN, DORDRECHT (NL)

(21) Appl. No.: 17/767,230

(22) PCT Filed: Oct. 8, 2020
(86) PCT No.: PCT/EP2020/078306

§ 371 Date: Apr. 7, 2022

(30) Foreign Application Priority Data
Oct. 10, 2019 (EP) 19202564.1
Oct. 31, 2019 (RU) 2019134972

(51) Int. Cl. G06T 7/149; G06T 7/12; G06T 7/00

(52) U.S. Cl. CPC G06T 7/149; G06T 7/12; G06T 7/0012; G06T 2200/24; G06T 2207/20081; G06T 2207/30048

(57) ABSTRACT

In a method of segmenting a medical image, a segmentation of the medical image is displayed (102) to a user, the segmentation comprising a contour representing a feature in the medical image. A user input is then received (104), the user input indicting a correction to the contour in the segmentation of the medical image. A shape constraint is determined (106) from the contour and the indicated correction to the contour and the shape constraint is provided (108) as an input parameter to a segmentation model to perform a new segmentation of the medical image.

### FIELD OF THE INVENTION

Embodiments herein relate to image processing, particularly but non-exclusively, to segmenting a medical image.

### BACKGROUND OF THE INVENTION

Image segmentation whereby a model is fit to features in an image in a fully automated or interactive manner, has a broad range of applications in medical image processing. One method of image segmentation is Model-Based Segmentation (MBS), whereby a triangulated mesh of a target structure (such as, for example, a heart, brain, lung etc.) is adapted in an iterative fashion to features in a medical image. Segmentation models typically encode population-based appearance features and shape information. Such information describes permitted shape variations based on real-life shapes of the target structure in members of the population. Shape variations may be encoded, for example, in the form of Eigenmodes which describe the manner in which changes to one part of a model are constrained, or dependent, on the shapes of other parts of a model. Model-Based Segmentation is described, for example, in the paper Ecabert et al. (2008): “Automatic Model-Based Segmentation of the Heart in CT images”; IEEE Trans. Med. Imaging 27 (9), 1189-1201.

In real-world medical images, local image artefacts or noise may degrade the fitting result such that the resulting segmentation is not an accurate fit to the image features. It is thus an object of the disclosure herein to provide improved methods and systems for segmenting a medical image, for example in the presence of noise or other image artefacts.

### SUMMARY OF THE INVENTION

As described above, noisy images or images comprising artefacts may result in poor image segmentation. In such situations, interactive tools exist to enable a user to edit the resulting fit, typically based on the user's interpretation of where the real boundaries of the features in the image lie. For example, a user may be able to drag (e.g. deform) or re-draw a portion of a contour in a segmentation to better align the contour of the segmentation with a boundary in the image.

Although image adaptive tools may provide efficiency gains, allowing a user to manually alter a segmentation in this manner has the disadvantage that the user's changes are not constrained by the same constants and population knowledge as encoded in the model performing the fit. As such, resulting manual alterations may not, for example, be anatomically consistent with other portions of the segmentation. It is thus an object of the current disclosure to improve upon these issues and provide systems and methods that better incorporate user feedback and alterations to a fit when segmenting a medical image.

Thus according to a first aspect, there is provided a method of segmenting a medical image. The method comprises displaying a segmentation of the medical image to a user, the segmentation comprising a contour representing a feature in the medical image. The method then comprises receiving a user input, the user input indicting a correction to the contour in the segmentation of the medical image. The method then comprises determining a shape constraint from the contour and the indicated correction to the contour, and providing the shape constraint as an input parameter to a segmentation model to perform a new segmentation of the medical image.

In this way, a user may indicate a correction to the contour and the correction may be taken into account by the segmentation model and used to perform a new segmentation of the medical image. The new segmentation thus incorporates the user's feedback (e.g. correction) whilst also providing a fit to the medical image that still conforms with the constraints and population statistics that are encoded into the segmentation model. In this way a better and more anatomically accurate correction to a segmentation of a medical image may be obtained.

According to a second aspect there is a system for segmenting a medical image. The system comprises a memory comprising instruction data representing a set of instructions, a user interface for receiving a user input, a display for displaying to the user, and a processor configured to communicate with the memory and to execute the set of instructions. The set of instructions, when executed by the processor, cause the processor to send an instruction to the display to display a segmentation of the medical image to the user, the segmentation comprising a contour representing a feature in the medical image. The instructions further cause the processor to receive a user input from the user interface, the user input indicting a correction to the contour in the segmentation of the medical image, determine a shape constraint from the contour and the indicated correction to the contour, and provide the shape constraint as an input parameter to a segmentation model to perform a new segmentation of the medical image.

According to a third aspect there is a computer program product comprising a computer readable medium, the computer readable medium having computer readable code embodied therein, the computer readable code being configured such that, on execution by a suitable computer or processor, the computer or processor is caused to perform the method of the first aspect.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows an example method according to some embodiments herein;

FIGS. 2a, 2b, and 2c show an example medical image, an example user input and an example new segmentation respectively, according to an embodiment herein;

FIGS. 3a and 3b illustrate example user inputs according to some embodiments herein; and

FIG. 4 shows an example system according to some embodiments herein.

### DETAILED DESCRIPTION OF EMBODIMENTS

As described above, when a segmentation is performed on an image such as a medical image, the resulting fit may not accurately reflect the boundaries of the image, particularly if the image is noisy or comprises image artefacts. In such a scenario, a user may manually redraw contours of the segmentation, according to what they see in the image. However such manual re-drawing may produce a result that is not in conformity with the population statistics and other constraints of the segmentation model that performed the original segmentation. In such a scenario, the user-corrected segmentation as a whole may thus not be anatomically correct or plausible, if, for example, the user's correction produces a result that falls outside of the segmentation model's constraints.

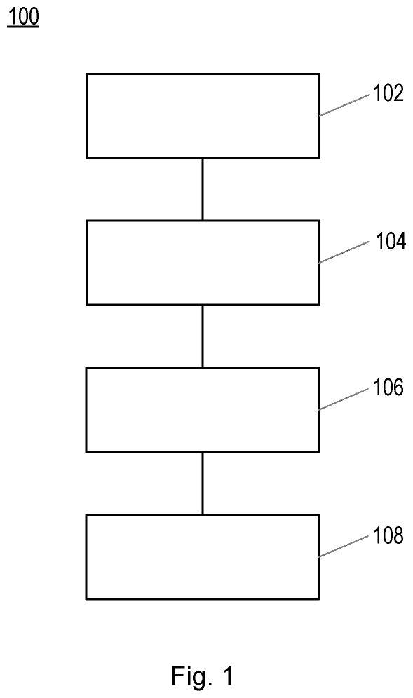

FIG. 1 shows an example method of segmenting a medical image according to some embodiments herein. Briefly, in a first block 102, the method comprises displaying a segmentation of the medical image to a user, the segmentation comprising a contour representing a feature in the medical image. In a second block 104, the method comprises receiving a user input, the user input indicting a correction to the contour in the segmentation of the medical image. In a third block 106, the method comprises determining a shape constraint from the contour and the indicated correction to the contour, and in a fourth block 108 the method comprises providing the shape constraint as an input parameter to a segmentation model to perform a new segmentation of the medical image.

As noted above, in embodiments herein, the user input is converted into an input that may be fed into the segmentation model to produce a new segmentation. The new segmentation thus incorporates the user's correction whilst producing a fit that also conforms with the segmentation model's other constants. Thus an improved segmentation may be produced when user feedback/correction is required compared to merely incorporating the user's feedback with no input from the segmentation model.

In more detail, the medical image may be acquired using any imaging modality. Examples of a medical image include, but are not limited to, a computed tomography (CT) image (for example, from a CT scan) such as a C-arm CT image, a spectral CT image or a phase contrast CT Image, an x-ray image (for example, from an x-ray scan), a magnetic resonance (MR) image (for example, from an MR scan), an ultrasound (US) image (for example, from an ultrasound scan), fluoroscopy images, nuclear medicine images, or any other medical image. Although examples have been provided for the type of image, a person skilled in the art will appreciate that the teachings provided herein may equally be applied to any other type of image.

In any of the embodiments described herein, the medical image can be a two-dimensional image, a three-dimensional image, or any other dimensional image. In embodiments where the medical image comprises a two-dimensional image, the medical image may comprise a plurality (or set of) pixels. In embodiments where the medical image is a three-dimensional image, the medical image may comprise a plurality (or set of) voxels.

As noted above, the medical image comprises a feature, such as an anatomical feature. For example, the medical image may comprise an image of a (or a part of a) body part or organ (e.g. an image of a heart, lungs, kidneys etc.). The feature may comprise a portion of said body part or organ. Although examples of organs have been provided, the skilled person will appreciate that these are examples only and that the medical image may comprise other body parts and/or organs.

In block 102 of the method 100, a segmentation of the medical image is displayed to a user. The skilled person will be familiar with different methods of segmenting a medical image. However, in brief, segmentation involves using a model (referred to herein as a “segmentation model”) in order to determine, for example, the location and size of different anatomical features therein. In some segmentation processes the image may be converted or partitioned into portions or segments, each portion representing a different feature in the image. Different types of models may be used.

For example, in some embodiments, the segmentation may comprise a model-based segmentation (MBS). The skilled person will be familiar with model-based segmentation. However, briefly, model-based segmentation comprises fitting a model of an anatomical structure to an anatomical structure in an image. Models used in model-based segmentation can comprise, for example, a plurality of points (such as a plurality of adjustable control points), where each point of the model may correspond to a different point on the surface of the anatomical structure. Models may comprise meshes comprising a plurality of segments, such as a polygon mesh comprising a plurality of polygon segments. In some embodiments the segmentation model (e.g. the model used to segment the medical image) comprises a mesh comprising a plurality of polygons (for example, a triangular mesh comprising a plurality of triangular segments or any other polygon mesh). The skilled person will be familiar with such models and appropriate model-based image segmentation processes.

As will be described in more detail below, in other embodiments, the segmentation may be performed using a machine learning model that has been trained to provide an outline of the structure(s) in the medical image. Put another way, the segmentation model may comprise a machine learning model trained to segment a medical image. Examples of machine learning models that may be used in embodiments herein comprise, but are not limited to Deep Learning models such as U-Nets or F-Nets which may be trained to take as input a medical image and produce as output a pixel level annotation of the features (or structures) in a medical image. The skilled person will be familiar with Deep Learning models and training methods for Deep Learning models. For example, such a machine learning model may be trained using training data comprising example inputs and annotated outputs (ground truths) e.g. example medical images and correctly segmented versions of the same medical images, respectively.

Although examples have been provided based on model-based segmentation and machine learning model segmentation, it will be appreciated that the teachings herein may also be applied to other segmentation models and processes used to segment a medical image.

In block 102 of FIG. 1, a segmentation of the medical image, produced as described above is displayed to the user. In some embodiments, the method may further comprise displaying the medical image to the user and overlaying the segmentation over the displayed medical image. The segmentation comprises a contour representing a feature (e.g. a fit to a feature) in the medical image. The contour may be a 2-dimensional contour (e.g. a line) or a 3-dimensional contour (e.g. a surface) that delineates the feature in the image. For example the contour may outline a boundary, an edge of a feature, where the feature meets or joins another body part or organ, or any other aspect of the feature in the medical image.

In block 104, the method comprises receiving a user input, the user input indicting a correction (e.g. improvement) to the contour in the segmentation of the medical image. The user input may indicate, for example, a corrected location of the contour in the medical image.

In some embodiments, the user input may comprise an indication of one or more user selected pixels (if the medical image is a 2D image) or voxels (if the medical image is a 3D image) in the displayed image that form part of the feature (e.g. part of boundary of the feature) in the image. For example, the user may click, or draw a line on the displayed medical image and/or the displayed segmentation to indicate where the actual boundary lies in the medical image.

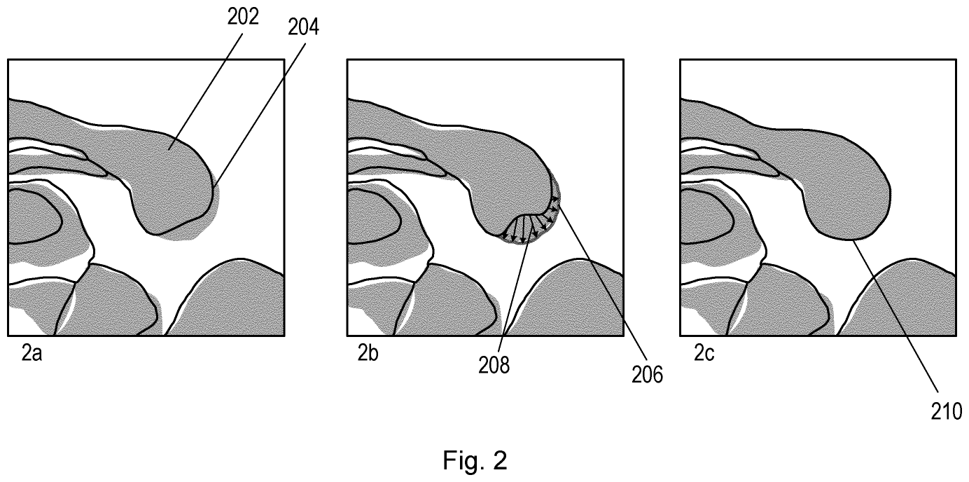

This is illustrated in FIG. 2. In this example, the medical image comprises an image of the brain comprising a ventricle 202. FIG. 2a shows the ventricle 202 and a contour 204 forming part of a segmentation of the ventricle 202. As can be seen in FIG. 2a, the contour 204 of the ventricle is not properly matched, which may be due, for example, to sub-optimal boundary detectors. The user thus provides a user input indicting a correction to the contour in the segmentation of the medical image, as shown in FIG. 2b. In this embodiment, the user input comprises a line of pixels 206, that indicate the correct boundary of the ventricle 202, as observed by the user.

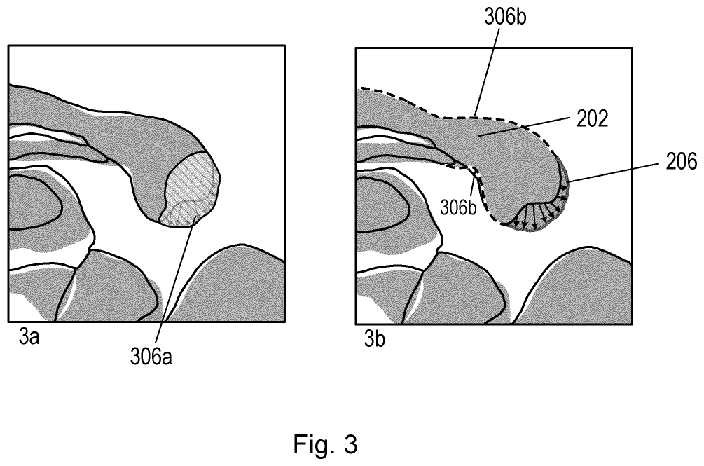

Although the user input is described as a line in FIG. 2b, the skilled person will appreciate that other user inputs indicting a correction to the contour in the segmentation of the medical image are possible. For example, as shown in FIG. 3a, in some embodiments, the user input may comprise a shaded region 306a of the medical image, an outer edge of which indicates the edge of the (underlying) feature in the medical image. For example, the user may draw or select a region in the image.

In some embodiments, the user input may comprise, for example, an indication of a voxel or pixel in the medical image. For example, the user input may comprise a “click” point on the image. In such embodiments, the user indicated pixel/voxel may trigger selection of a region around the user indicated pixel/voxel (e.g. around the click point) that is dynamically defined by a gradient boundary around the user indicated pixel/voxel. The user may thus edit the segmentation with minimal effort.

In some embodiments, the method 100 may further comprise extrapolating the one or more user selected pixels or voxels along a gradient boundary in the image to obtain the indicated correction to the contour. This enables a fuller correction to the contour to be determined with minimal input from the user.

This is illustrated in FIG. 3b which shows a user input in the form of a line of pixels 206. In this example, the line is extrapolated along the boundary of the feature 202, to form the extrapolated gradient boundary 306b. In this embodiment, both the user input 206 and the extrapolated gradient boundary 306b may be used as the correction to the contour in the segmentation of the medical image.

The original user input may be extrapolated, for example, using the “live-wire” method (e.g. part of the MLContour Library). The skilled person will be familiar with live-wire, and other methods of extrapolating a contour, such as, for example the “smart brush” method in Photoshop®.

Turning back to FIG. 1, in block 106 the method comprises determining a shape constraint from the contour and the indicated correction to the contour. Generally, the shape constraint may comprise any form of information that may be input to (e.g. taken into consideration by) a segmentation model to perform a new segmentation of the medical image.

For example, in some embodiments, the shape constraint comprises a spring-like force. When input into the segmentation model to perform a new segmentation of the medical image, the spring-like force may have the effect on the segmentation model of encouraging the contour of the model towards the indicated corrected contour.

The spring-like force may be calculated from the relative positions of the contour (e.g. the output of the original segmentation) and the indicated correction to the contour (as provided by the user). The magnitude of the spring-like force may be determined, for example, proportional to the distance between the contour and the indicated corrected contour. In some examples, the magnitude of the spring-like force may be determined, for example, proportional to the average (mean, median), maximum or minimum distance between the contour and the indicated corrected contour.

In some embodiments, the shape constraint comprises a vector field of spring-like forces. This is illustrated in FIG. 2b by the arrows 208. Each arrow 208 indicates the magnitude and direction of a spring-like force needed to move a point on the contour 204 to the corrected contour position 206 as indicated by the user.

In some embodiments, determining a shape constraint from the contour and the indicated correction to the contour comprises determining the vector field of spring-like forces based on distances between the contour and the indicated correction to the contour.

For example, the vector field of spring-like forces may be proportional to the distance between the contour and the indicated corrected contour at each point along the contour.

In some embodiments, the vector field of spring-like forces describes (or may be thought of as) a deformation field indicating the manner in which the contour may be deformed to produce the indicated correction to the contour.

Mathematically speaking, the segmentation model may comprise one or more eigenmodes, and the vector field of spring-like forces may act on the one or more eigenmodes when performing the new segmentation of the medical image. For example, the spring-like force or the vector of spring-like forces may be projected onto the eigenvectors of the segmentation during the fitting process. The skilled person will be familiar with Eigenmodes. But in brief, an Eigenmode may describe how different parts of the model are able to deform relative to one another in order to fit the model to the medical image. Put another way, Eigenmodes may describe different vibrational modes of a model (e.g. the manner in which the model may be expanded, shrunk or otherwise globally deformed in a manner consistent with the underlying population that the model is derived from). Eigenmodes may generally be used to deform the segmentation model in a self consistent way so as to only produce anatomically feasible fits to the medical image. Eigenmodes may be considered free-of-cost deformation, and thus may be used to compensate external forces (appearance, springs).

In other embodiments, the shape constraint may take other forms. For example, more generally, the shape constraint may comprise an input describing a change in position of a portion of a segment. The skilled person will appreciate that the shape constraint may comprise any input to a segmentation model that encourages the model to produce an output fit that is closer to the user indicated corrected contour.

Turning back now to FIG. 1, in block 108, the method comprises providing the shape constraint as an input parameter to a segmentation model to perform a new segmentation of the medical image.

In some embodiments, the shape constraint may be provided, for example, in the form of one or more input vectors, e.g. in [x,y] format, each [x,y] spring-force vector being associated with a particular point on the medical image.

Spring forces may be added to many existing segmentation models in the form of additional input parameters (e.g. in an ad hoc manner).

Generally, the segmentation (e.g. shape) model is placed on the image and adapts its boundaries using encoded (trained) appearance parameters. Internal forces act to keep the shape close to the population mean (shape+eigenvectors), external forces pull to image locations matching the encoded appearance. The external spring forces act against internal forces. The stronger the external spring forces are, the more likely the springs will have (almost) zero length in the equilibrium state, e.g. there will be a pull force as long as the spring has a positive length. Finally an equilibrium state is reached in the process and this is output as the best fit to the image. This process is used by, for example, active shape models.

The user input, e.g. the vector field of spring-like forces (or deformation field) derived therefrom, serves as an additional force for the segmentation (e.g. shape) model and changes the final equilibrium state.

Weights can be added to emphasize one or other of the forces. In some embodiments, the contribution of the spring-like forces (or deformation field) may be strong. Put another way, in some embodiments, the method may further comprise adjusting a weight in the segmentation model to increase a weighting given to the vector-field of spring-like forces compared to other forces in the segmentation model when performing the new segmentation of the medical image. In this way, the user input may be prioritised (or made more important) over other forces in the model, thus ensuring the outputted fitted contours of the new segmentation lie as close as possible to the user input.

A new segmentation for the ventricle example shown in FIG. 2a and described above is illustrated in FIG. 2c which shows the aforementioned ventricle 202 and a contour 210 of the new segmentation of the image. Generally therefore, in some embodiments, the method 100 may further comprise overlaying the new segmentation onto the displayed medical image.

In this way, the shape constraint is provided to the model to improve the segmentation, enabling the user input to factored into the segmentation to improve the resulting fit. The boundary of the user's pixel/voxel annotation (e.g. the indicated correction to the contour) defines local spring-like forces towards the surface representation, which in turn acts as a constraint to the deformation by maintaining e.g. a level of surface smoothness or other shape properties encoded in the underlying model. As described above, the user no longer manipulates the contour/surface directly, but annotates pixels/voxels locally and these annotations are used to derive spring like forces (or deformation forces) towards the contour or surface from this annotation. This enables a smooth and intuitive user interaction with surface based shape representations.

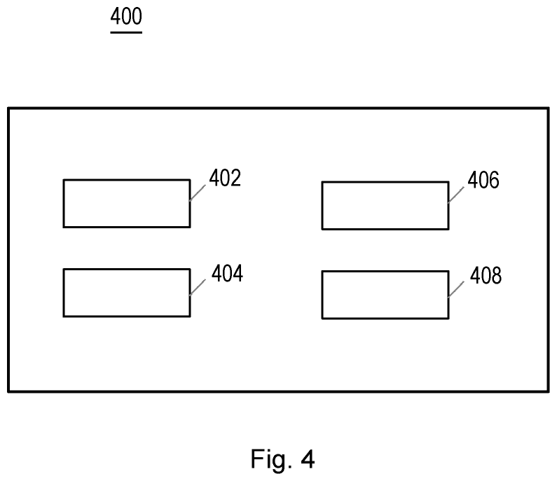

Turning now to FIG. 4, in some embodiments there is a system 400 for segmenting a medical image. With reference to FIG. 4, the system 400 comprises a processor 402 that controls the system 400 and that can implement the method 100 as described above. The system further comprises a memory 404 comprising instruction data representing a set of instructions. The memory 404 may be configured to store the instruction data in the form of program code that can be executed by the processor 402 to perform the method described herein. In some implementations, the instruction data can comprise a plurality of software and/or hardware modules that are each configured to perform, or are for performing, individual or multiple steps of the method described herein. In some embodiments, the memory 404 may be part of a device that also comprises one or more other components of the system 400 (for example, the processor 402 and/or one or more other components of the system 400). In alternative embodiments, the memory 404 may be part of a separate device to the other components of the system 400.

In some embodiments, the memory 404 may comprise a plurality of sub-memories, each sub-memory being capable of storing a piece of instruction data. For example, at least one sub-memory may store instruction data representing at least one instruction of the set of instructions, while at least one other sub-memory may store instruction data representing at least one other instruction of the set of instructions. Thus, according to some embodiments, the instruction data representing different instructions may be stored at one or more different locations in the system 400. In some embodiments, the memory 404 may be used to store the medical image, the user input, the segmentation model and/or any other information acquired or made by the processor 402 of the system 400 or from any other components of the system 400.

The processor 402 of the system 400 can be configured to communicate with the memory 406 to execute the set of instructions. The set of instructions, when executed by the processor may cause the processor to perform the method described herein. The processor 402 can comprise one or more processors, processing units, multi-core processors and/or modules that are configured or programmed to control the system 400 in the manner described herein. In some implementations, for example, the processor 402 may comprise a plurality of (for example, interoperated) processors, processing units, multi-core processors and/or modules configured for distributed processing. It will be appreciated by a person skilled in the art that such processors, processing units, multi-core processors and/or modules may be located in different locations and may perform different steps and/or different parts of a single step of the method described herein.

The system 400 further comprises a display 406. The display may comprise, for example, a computer screen, a screen on a mobile phone or tablet, a screen forming part of a medical equipment or medical diagnostic tool or any other display capable of displaying, for example the medical image and/or the segmentation to a user.

The system 400 further comprises a user interface 408. The user interface allows a user to provide input to the processor. For example, the user interface may comprise a device such as a mouse, a button, a touch screen, an electronic stylus, or any other user interface capable of receiving an input from a user.

Briefly, the set of instructions, when executed by the processor 402 of the system 400 cause the processor 402 to send an instruction to the display to display a segmentation of the medical image to the user, the segmentation comprising a contour representing a feature in the medical image and receive a user input from the user interface, the user input indicting a correction to the contour in the segmentation of the medical image. The processor is further caused to determine a shape constraint from the contour and the indicated correction to the contour, and provide the shape constraint as an input parameter to a segmentation model to perform a new segmentation of the medical image. These steps were described above in detail with respect to the method 100 and the details of the method 100 will be understood to apply equally to the operation of the system 400.

In some embodiments, the set of instructions, when executed by the processor 402 may also cause the processor 402 to control the memory 404 to store images, information, data and determinations related to the method described herein. For example, the memory 404 may be used to store the medical image, the segmentation model and/or any other information produced by the method as described herein.

In some embodiments, the processor is further caused to send instructions to the display to display the medical image on the display, overlay the segmentation on to the displayed medical image, and/or overlay the received user input onto the displayed medical image. Thus facilitating an intuitive method for the user to provide feedback to and update a segmentation of a medical image.

Turning now to other embodiments, in some embodiments there is a computer program product comprising a computer readable medium, the computer readable medium having computer readable code embodied therein, the computer readable code being configured such that, on execution by a suitable computer or processor, the computer or processor is caused to perform the method 100.

Variations to the disclosed embodiments can be understood and effected by those skilled in the art, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of segmenting a medical image, the method comprising:
displaying a segmentation of the medical image to a user, the segmentation comprising a contour representing a feature in the medical image;
receiving a user input, the user input indicting a correction to the contour in the segmentation of the medical image;
determining a shape constraint from the contour and the indicated correction to the contour; and
providing the shape constraint as an input parameter to a segmentation model to perform a new segmentation of the medical image.

2. A method as in claim 1 wherein the shape constraint comprises a spring-like force.

3. A method as in claim 1 wherein the shape constraint comprises a vector field of spring-like forces.

4. A method as in claim 3 wherein the vector field of spring-like forces describes a deformation field indicating the manner in which the contour may be deformed to produce the indicated correction to the contour.

5. A method as in claim 3 wherein determining (106) a shape constraint from the contour and the indicated correction to the contour comprises:
determining the vector field of spring-like forces based on distances between the contour and the indicated correction to the contour.

6. A method as in claim 3 wherein the segmentation model comprises one or more eigenmodes; and wherein the vector field of spring-like forces acts on the one or more eigenmodes when performing the new segmentation of the medical image.

7. A method as in claim 3 further comprising:
adjusting a weight in the segmentation model to increase a weighting given to the vector-field of spring-like forces compared to other forces in the segmentation model when performing the new segmentation of the medical image.

8. A method as in claim 1 wherein the segmentation model comprises a mesh comprising a plurality of polygons.

9. A method as in claim 1 wherein the segmentation model comprises a machine learning model trained to segment a medical image.

10. A method as in claim 1 wherein the method further comprises:
displaying the medical image; and
overlaying the segmentation and/or the new segmentation onto the displayed medical image.

11. A method as in claim 10 wherein the user input comprises an indication of one or more user selected pixels or voxels in the displayed medical image that form part of the feature in the medical image.

12. A method as in claim 11 further comprising:
extrapolating the one or more user selected pixels or voxels along a gradient boundary in the medical image to obtain the indicated correction to the contour.

13. A system for segmenting a medical image, the system comprising:
a memory comprising instruction data representing a set of instructions;
a user interface for receiving a user input;
a display for displaying to the user; and
a processor configured to communicate with the memory and to execute the set of instructions, wherein the set of instructions, when executed by the processor, cause the processor to:
send an instruction to the display to display a segmentation of the medical image to the user, the segmentation comprising a contour representing a feature in the medical image;
receive a user input from the user interface, the user input indicting a correction to the contour in the segmentation of the medical image;
determine a shape constraint from the contour and the indicated correction to the contour; and
provide the shape constraint as an input parameter to a segmentation model to perform a new segmentation of the medical image.

14. A system as in claim 13 wherein the processor is further caused to send instructions to the display to:
display the medical image on the display;
overlay the segmentation on to the displayed medical image; and
overlay the received user input onto the displayed medical image.

15. A non-transitory computer readable medium, storing instructions that, on execution by a suitable computer or processor, cause the computer or processor to:
display a segmentation of the medical image to a user, the segmentation comprising a contour representing a feature in the medical image;
receive a user input, the user input indicting a correction to the contour in the segmentation of the medical image;
determine a shape constraint from the contour and the indicated correction to the contour; and
provide the shape constraint as an input parameter to a segmentation model to perform a new segmentation of the medical image.
